(19) United States
(12) Patent Application Publication
(10) Pub. No.: US 2012/0090971 A1
(43) Pub. Date: Apr. 19, 2012

(54) TIMING DEVICE

(75) Inventor: David Bowen, Wakefield (GB)

(73) Assignee: Logicor Limited, Wakrfield (GB)

(21) Appl. No.: 13/258,197

(22) PCT Filed: Mar. 25, 2010
(86) PCT No.: PCT/GB10/00570

§ 371 Date: Dec. 13, 2011

(30) Foreign Application Priority Data
Mar. 25, 2009 (GB) 0905072.5

(51) Int. Cl. G04F 1/00

(52) U.S. Cl. 200/33 R

(57) ABSTRACT

The invention relates to a timing device for use with a cable, and also to a cable including said timing device. The device is formed so as to be movable between a first position in which electricity is prevented from flowing therethrough and a second position in which electricity can flow therethrough. When in the second position, the cable with which the device is provided, and apparatus connected to the cable is rendered electrically operable. The device is provided to allow electrical connection for a predetermined time period, such that at the end of the said time period, the device has moved back to the first position. The provision of the device as part of the cable allows the same to be positioned in a room for easier user access and hence user operation.

This invention relates to a timing device, and particularly to a timing device for use with an electrical cable, such as for example an electrical extension cable, and a method of use thereof.

Although the following description refers almost exclusively to a timing device for use with an electrical extension cable having a plug located at a first end thereof and at least one socket located at a second end thereof, which, in the United Kingdom would be of the three pin type, it will be appreciated by persons skilled in the art that the present invention can relate to any type of electrical cable or electrical extension cable for use with any type of electrical plug and/or socket arrangement.

Conventionally, if a user wishes to use an electrical appliance, such as for example an iron, the user locates the plug, typically attached to the iron at the end of an electrical cable running between the iron housing and the plug, in a wall electrical socket. The user then actuates a switch associated with the wall socket to allow electrical current to pass from a mains power supply, through the wall socket, along the plug pins to electrical connections internally of the plug and along the electrical cable to the iron. A further operational switch may be associated with the iron to allow the electrical current being passed along the electrical cable to make contact with electrical connections in the iron if required. Once the user has finished with the iron, the user may switch the iron off by operating the iron operational switch, the wall socket switch and/or removing the plug from the wall socket, thereby stopping the flow of electrical current from the mains power supply to the iron.

However, a common problem is that a user may forget to switch the iron or other electrical appliance off after use, particularly if the user is a child or elderly person. This can lead to a waste of electrical power and/or over heating of the appliance, which may result in fire and/or damage to the appliance or locality in which the appliance is located.

In order to overcome this problem, the applicant has proposed a number of different types of timing devices for allowing electrical current to be supplied to electrical apparatus for a pre-determined time period. For example, International Patent Application WO2008/003786 discloses an electrical plug with a timing mechanism contained therein. The plug includes first and second electrical connection means which can communicate with each other to allow electrical charge to flow between the same. The plug includes movement means for allowing relative movement of the first and second electrical connection means between a first position, wherein electrical connection is made between the electrical connection means, and a second position, wherein there is no electrical connection between the electrical connection means. The relative movement takes place over a pre-determined time period following actuation of the movement means and this time period is sufficient to allow use of the electrical apparatus. The first electrical connection means is associated with at least a first part of the plug and the second electrical connection means is associated with a second part of the plug and the movement means also allows relative movement between the plug parts in the pre-determined time period. Actuation of the timing mechanism is caused by movement of the plug parts relative to each other. A similar timing mechanism is disclosed in the applicant's co-pending British Patent Application GB0808596.1 for an electrical plug adaptor which includes one or more electrical sockets associated with the same, and British Patent Application GB0808796.7 for an electrical wall socket.

A problem with the abovementioned timing devices is that the plug, plug adaptor and/or wall socket have to be easily accessible by a user in order to actuate the same. This is not always possible or easy to do if the timing device is located behind an item of furniture, if the timing device is located on or adjacent a floor surface and/or the like. In addition, it is often the case that a plurality of plugs and items of electrical apparatus are required for a particular application. Each plug and item of electrical apparatus would typically require separate actuation of the timing devices associated therewith, which would be time consuming and could result in all the items of electrical apparatus being actuated and deactivated non-synchronously. For example, a computer station may have a computer hard drive, monitor display, printer and scanner which may each have an electrical plug associated with the same which are typically engaged in a multiple socket electrical extension cable. In another typical example, a television system may have a television display, a set top box and a video and/or DVD player which may each have an electrical plug associated with the same which are typically engaged in a multiple socket electrical extension cable. Due to the location of such electrical appliance groupings, such as in a main living room of a house or main office of a business, the extension cable is often hidden from view for aesthetic reasons. This often results in the extension cable being placed behind an item of furniture such as a desk or TV cabinet, thereby making access to the plug and/or wall socket difficult.

It is therefore an aim of the present invention to provide a timing device which is suitable for use with an electrical cable or electrical extension cable and which allows easy access to the same.

It is a further aim of the present invention to provide an electrical cable or extension cable including a timing device.

It is a yet further aim of the present invention to provide a method of using a timing device, an electrical cable and/or an electrical extension cable including a timing device.

According to a first aspect of the present invention there is provided a timing device for use with an electrical cable, said device locatable between two ends of the cable and including cable input means and cable output means, said device further including at least first electrical connection means for allowing electrical connection with a first cable part associated with the cable input means in use and at least second electrical connection means for allowing electrical connection with a second cable part associated with the cable output means in use, said device further including movement means arranged to allow relative movement of the at least first and/or second electrical connection means, or an electrical switch means associated with the same, between a first position, wherein electrical charge can flow therebetween, and a second position, wherein the flow of electrical charge is prevented, the relative movement taking place over a pre-determined time period following actuation or on actuation of said movement means.

Thus, the present invention allows electrical current to flow through the timing device between first and second cable parts associated therewith in use during said pre-determined time period. This allows electrical supply along the electrical cable to be automatically switched off after said pre-determined time period without further user intervention, thereby preventing items of electrical equipment used with or associated with the electrical cable being left on for a longer time period than is required. In addition, it can be used to provide a means of limiting the use of electrical equipment to a particular user. The timing device can be placed at such a point on the cable to allow easy access to the same and to allow simultaneous actuation/deactivation of a plurality of plugs and/or sockets associated with the same if used with an extension cable, thereby allowing substantially simultaneous actuation/deactivation of an electrical supply in a timed manner to a plurality of items of electrical apparatus. The external appearance of the timing device can be such so as to be aesthetically pleasing, thereby allowing the same to be placed on view in a room, for example, which allows easier user access to the same. The remaining cabling, plugs and sockets can be hidden from view, thereby removing the aesthetically displeasing elements of the electrical apparatus from view.

The timing device typically does not use any electrical supply when in an “off” or “out of use” position, thereby saving electricity.

The electrical cable is typically of a type to allow electrical charge to flow along the same.

Preferably the timing device is provided a spaced distance from each end of the cable.

Preferably the electrical cable is in the form of an extension cable having a first end with electrical plug means provided thereon or associated therewith, and a second end with one or more electrical sockets provided thereon or associated therewith. The timing device is typically placed between the plug and the sockets. One of the first cable part or the second cable part can be associated with the first end of the cable and the other of the first cable part or the second cable part can be associated with the second end of the cable.

The first and second cable parts can form part of the same electrical cable or can be two separate electrical cables.

The timing device can be located at any suitable position on the cable between the first and second ends. For example, the timing device can be located at a point on the cable which is most easily accessible by a user in use. In one embodiment the timing device is located substantially centrally and a spaced distance between the first and second ends.

Preferably the timing device includes at least first and second parts or housing parts.

Preferably the movement means allows relative movement of the first and/or second parts. Movement of the first and/or second parts typically allows the electrical switch means or the at least first and second electrical connection means to move between the first and second positions.

Preferably the at least first and second parts at least partially form a housing defining the timing device.

Preferably the at least first and second parts are slidably mounted to allow sliding movement of said parts between said first and second positions.

In one embodiment biasing means are provided to bias the timing device from the first “in-use” position to the second “out-of-use” position.

The biasing means can include any or any combination of resilient biasing means, wherein the uncoiling or flexing of resilient means takes place substantially over said pre-determined time period; pneumatic means, wherein the passage or movement of air or gas from a first location to a second location takes place over said pre-determined time period, hydraulic means, wherein the passage of water or fluid from a first location to a second location takes place over said pre-determined period; mechanical means and/or the like.

The biasing means can include a coiled or compressible spring, a rod and piston type of arrangement and/or the like.

In one embodiment, the potential energy stored in the movement means can be converted to kinetic energy on actuation of the movement means.

Preferably the first part includes or forms a base of the timing device and the second part includes or forms a top of the timing device. In the second position, the second part is biased away or is furthest from the first part and in the first position, the second part is moved towards or is closer to the first part.

Preferably a user actuates the timing device or movement means by moving the second part towards the first part. This can take place as a result of a user depressing or applying a substantially vertical force to the second part relative to the first part, for example.

In one embodiment the movement means moves automatically from the second position to the first position after a pre-determined time period has elapsed following actuation thereof (i.e. there is a delay following actuation before the timing mechanism starts).

One or more support means can be associated with the first part and/or base of the timing device to allow the device to be supported on a suitable surface in use. In a preferred embodiment the support means includes one or more support feet.

The at least first and second parts are typically formed such that in the first and/or second positions, user access to the interior of the timing device is substantially prevented. This prevents any electrical connections from being exposed when electrical current is flowing through the same in use.

The amount of movement or speed of movement of the movement means of the at least first and second parts, switch means and/or the at least first and/or second electrical connection means typically defines the pre-determined time period of the timing means for which electrical current can flow through the device. The timing means can be an actual timer device, such as a clock or countdown, can be as a result of the inherent timing of movement of a component when actuated and/or the like

Preferably the pre-determined time period is a sufficient time period to allow a user to operate an item of electrical item of apparatus and/or to perform one or more functions with the same that is associated with the timing device.

In one embodiment a plurality of pre-determined time periods can be set by the user, third party and/or manufacturer can select which time period they wish to use with the timing device.

Preferably adjustment means are provided with the timing device to allow user adjustment or selection of the one or more pre-determined time periods. The adjustment means can be in the form of a screw in one example which adjusts the distance travelled by a spring, piston and/or the like.

In one embodiment the one or more pre-determined time periods could be set remotely using processing means associated with the timing device.

The pre-determined time period or periods can be minutes, hours, days and/or the like depending on the requirement by the manufacturer, user and/or particular item of electrical equipment associated with the same.

In one embodiment a pre-determined time interval needs to pass before the timing device can be re-actuated after use.

The first and second electrical connection means can be associated with the first and second parts respectively, such that movement of the first and second parts causes the first and second electrical connection means to move between the first and second positions. Alternatively, the movement of the first and second parts can cause movement of switching means associated with the electrical connection means, either directly or indirectly, between the first and second positions.

In one embodiment operational means can be associated with the timing device to allow the device to be moved between operational and non-operational conditions. With the timing device in the non-operational condition, the electrical cable or extension cable can typically be used in a conventional manner without timed use.

Preferably the timing device includes indication means to allow a user to determine the status of the timing device. The indication means can include any or any combination of audio, visual and/or kinaesthetic means. For example the visual indication means can include one or more lights showing whether the device is operational, non-operational, actuated, non-actuated, about to change status and/or the like. The audible means can include an alarm and/or the like.

Preferably the timing device includes suitable wiring means to allow the wires of an electrical cable or cable parts to be connected to the same. The timing device can be retrofitted to an existing cable or can be manufactured in position on a cable or between at least two cable parts.

The electrical cable input means and output means can be provided on the same side of the housing of the timing device or can be provided on different sides of the housing as required.

Sealing means can be provided between the first and second parts to prevent dirt or moisture from entering the timing device housing.

Preferably each of said at least first and second parts defines at least one or more recesses therein. The recesses are typically used for the containment of the components of the timing device.

According to a second aspect of the present invention there is provided a method of using a timing device for use with an electrical cable, said device locatable between two ends of the cable and including cable input means and cable output means, said device further including at least first electrical connection means for allowing electrical connection with a first cable part associated with the cable input means in use and at least second electrical connection means for allowing electrical connection with a second cable part associated with the cable output means in use, said method including the step of actuating movement means associated with the device to allow relative movement of the at least first and/or second electrical connection means or an electrical switch means associated with the same between a first position, wherein electrical charge can flow therebetween, and a second position, wherein the flow of electrical charge is prevented, the relative movement taking place over a pre-determined time period following actuation or on actuation of said movement means.

According to further independent aspects of the present invention there is provided an electrical cable including a timing device; an electrical extension cable including a timing device; a method of using an electrical cable and a method of using an electrical extension cable.

An embodiment of the present invention will now be described with reference to the accompanying figures, wherein:

FIG. 1a is a perspective view of an extension cable including a timing device according to an embodiment of the present invention in an “out-of-use” or second position;

FIG. 1b shows the position of the electrical switch in FIG. 1a;

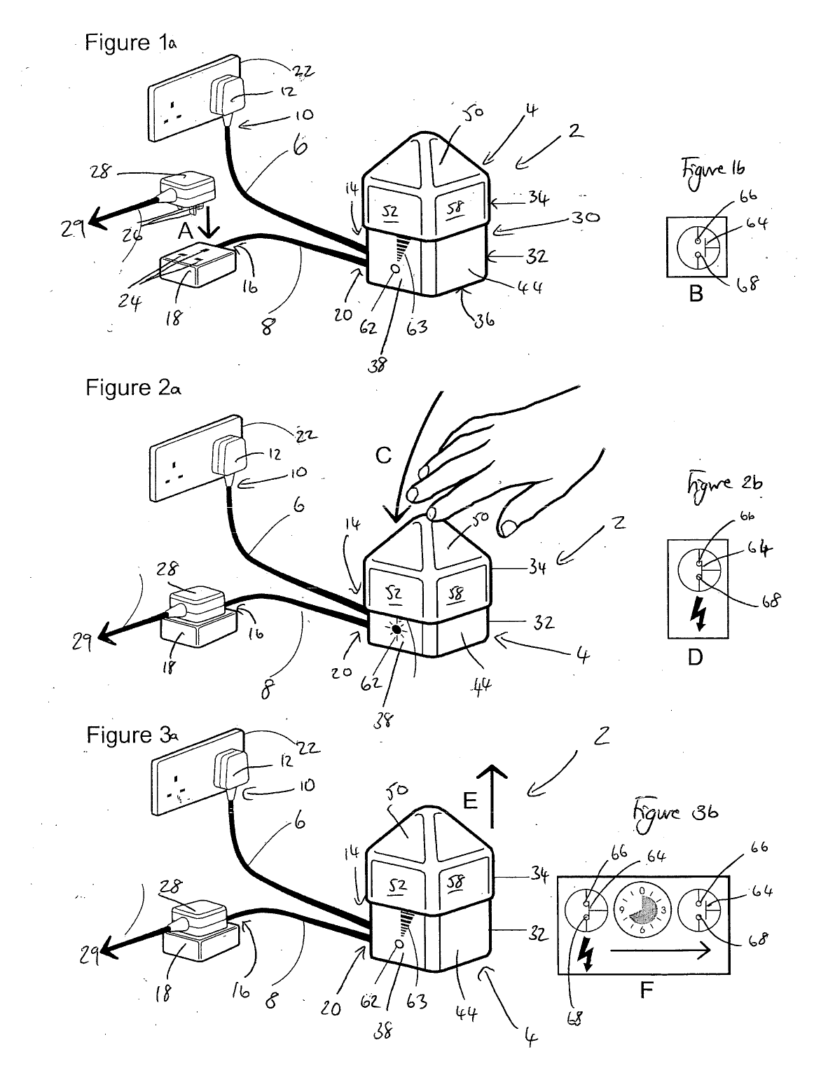

FIG. 2a is a perspective view of the extension cable in FIG. 1a following actuation of the timing device therewith to an “in-use” or first position;

FIG. 2b shows the position of the electrical switch in FIG. 2a,

FIG. 3a is a perspective view of the extension cable in FIG. 2a during movement of the same between the first and second positions;

FIG. 3b shows the position of the electrical switch in FIG. 3a;

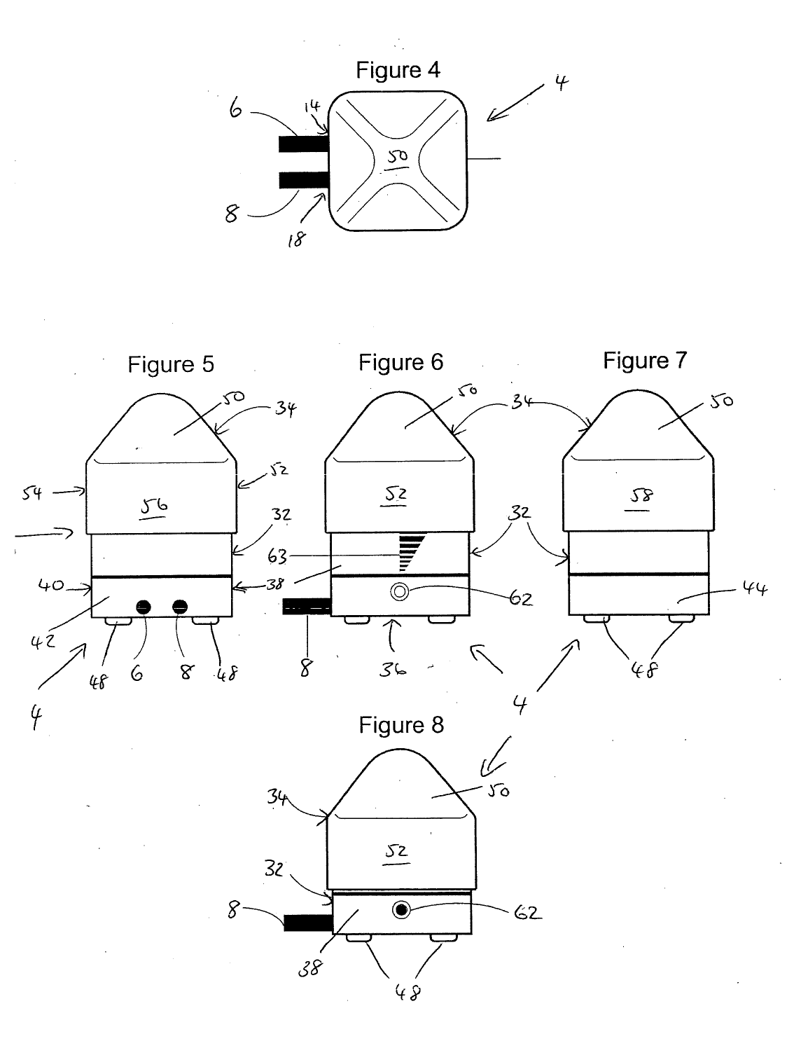

FIGS. 4-7 show a top view, first side view, front view and second side view of the timing device in FIG. 1a-3a respectively;

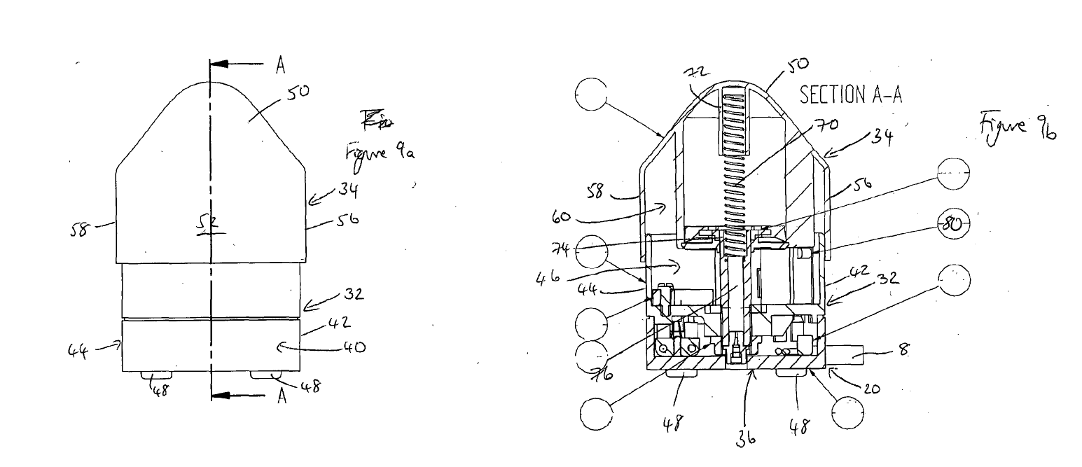

FIG. 8 shows a front view of the timing device of FIGS. 1a-7 following actuation showing the visual LED indicator in an “on” position;

FIGS. 9a and 9b show a side view of the timing device in FIGS. 1a-8, and a cross sectional view taken along line A-A in FIG. 9a respectively.

Referring to the figures, there is illustrated an extension cable 2 including a timing device 4 which allows electrical current to flow along the extension cable for a pre-determined period of time before automatically switching off the electrical current flow. This allows electrical apparatus used with the extension cable to be used for the pre-determined period of time.

More particularly, the extension cable 2 includes a first cable part 6 and a second cable part 8. First cable part 6 has a first end 10 with an electrical plug 12 provided thereon, and a second end 14 which is connected to first electrical connection means in the timing device 4. Second cable part 8 has a first end 16 with an electrical socket 18 provided thereon, and a second end 20 which is connected to second electrical connection means in the timing device 4.

Electrical plug 12 is typically located in a complementary electrical wall socket 22 in use to allow electrical current to flow from a mains electrical supply, through the wall socket 22 and along the first cable part 6 to the timing device 4.

Electrical socket 18 is of a type used in the UK having three apertures 24 for the location of three corresponding shaped electrical pins 26 of a further electrical plug 28. The further electrical plug 28 is typically connected to an item of electrical equipment, as shown by arrow 29, for which a timed electrical supply is required in use.

When the timing device is actuated, electrical current can flow from the same, through socket 18 and further plug 28 to the item of electrical equipment. The timing device allows the electrical current to flow for the pre-determined time period.

It will be appreciated that a plurality of electrical sockets 18 can be provided but only a single socket is shown for the purposes of clarity (i.e. the extension cable can be a multiple socket extension cable). In addition, the apparatus can be adapted for use with any suitable plug and/or socket arrangement, such as for example so that it can be compatible with electrical supplies in foreign countries which may use a single electrical pin, two pins and/or the like.

It is to be noted that the wall socket, plugs and extension sockets can be used in the conventional manner.

The timing device 4 has a housing 30 defined by a first part which forms a base 32 of the housing, and a second part which forms a top 34 of the housing. More particularly, the base 32 includes a base surface 36, front wall 38, rear wall 40 and side walls 42, 44. A recess 46 is defined in base 32 for the location of at least some of the electrical and/or mechanical components of device 4. Support feet 48 are located on base surface 36 and protrude outwardly therefrom to support the device 4 on a suitable surface in use. Top 34 includes a dome shaped top surface 50, a front wall 52, rear wall 54 and side walls 56, 58. A recess 60 is defined in top 34 for the location of at least some of the electrical and/or mechanical components of device 4.

Although the housing 30 is shown in a particular shape in the illustrations, it will be appreciated that the housing 30 can be provided in any suitable shape and can be of any suitable size and/or the like.

Housing 30 has cable input means and cable output means in the form of suitably shaped apertures on side wall 42 of base 32.

Status indication means in the form of a light emitting diode (LED) 62 is provided on front wall 38 of base 32 to provide a visual indication to a user of whether the device 4 is operational, non-operational, has been actuated, the pre-determined time period of the device has run out or is close to running out and/or the like. An audible alarm, as shown by symbol 63, and/or vibration indication means can be included with device 4 in place of or in addition to LED 62. The LED is shown lit in FIG. 3a to shown the first actuated position has been reached. The LED is no lit in FIGS. 1a and 3c to show the second actuated position has been reached. A warning can be given via the LED or alarm when the timing device is about to reach the second position, thereby giving a user sufficient time to complete or save the function they are performing on the electrical apparatus prior to electrical power being automatically switched off. Re-actuation of the device could take place prior to completion of a previous actuation stage if required if continuous power is required.

The top 34 is slidably mounted with respect to base 32 and is movable between a second “out-of-use” position, as shown in FIG. 1a, to a first “in-use” position, as shown in FIG. 2a. The cross sectional dimensions of front wall 52, rear wall 54 and side walls 56, 58 of top 34 are slightly larger than the cross sectional dimensions of front wall 38, rear wall 40 and side walls 42, 44 of base 32 to allow at least part of the interior surface of top 34 to be slidably moved relative to the exterior surface of base 32 in use.

In order to move the device 4 from the second out-of-use position to the first in-use position, a user depresses top 34 and slidingly moves top 34 towards base 32, as shown by Arrow C in FIG. 2a. This causes a switch 64 contained within housing 4 to be moved from an “out-of-contact” position with first and second electrical connections 66, 68, as shown in FIG. 1b, to an “in-contact” position, as shown in FIG. 2b.

Movement means contained in device 4, as will be described in more detail below, resiliently biases the top 34 from the first position, once actuated, to the second position, as shown by arrow E in FIG. 3a. The time taken for the movement of top 34 from the first position to the second position represents the pre-determined period of the timing device in this example. This movement causes switch 64 to move from the “in-contact” position to the “out-of-contact” position, as shown in FIG. 3b.

More particularly, resilient biasing means in the form of a compressible spring 70 is provided in top 34 and is held in place between sleeve portions 72, 74 defined in the recess of top 34. A post member 76 in base 32 protrudes upwardly from base surface 36. As top 34 is slidingly moved towards base 32 during actuation, lower end 78 of spring 70 is forced against the top of post member 76, thereby compressing spring 70. The time taken for the spring 70 to decompress or partially uncoil corresponds to the pre-determined time period. Thus, for example, a relatively stiff spring can be used to allow a suitable time period to pass sufficient to allow one or more functions to be performed on the item of electrical apparatus being supplied with the electrical current. Stop means are provided by sleeve 72 to limit the downward movement of top 34 relative to base 32. Other suitable stop means could be used if required.

The switch 64 is in the form of a micro switch and is actuated by an arm 80 which moves with top 34. In the first position, arm 80 maintains switch 64 in contact with the first and second electrical connections until the second position is reached, wherein arm 80 is moved a spaced distance from switch 64, thereby releasing electrical contact between the first and second electrical connections.

The components of the housing can be formed from any or any combination of suitable materials, such as plastic, metal, wood, rubber and/or the like.

1-40. (canceled)

41. A timing device (4) in combination with an electrical cable, said device locatable between two ends (10, 14) of the cable and including cable input means and cable output means, said device (4) further including at least first electrical connection means (66) for allowing electrical connection with a first cable part (6) associated with the cable input means in use and at least second electrical connection means (68) for allowing electrical connection with a second cable part (8) associated with the cable output means in use, said device (4) further including movement means arranged to allow relative movement of the at least first and/or second electrical connection means (66, 68) or an electrical switch means (64) associated with the same between a first position, wherein electrical charge can flow therebetween, and a second position, wherein the flow of electrical charge is prevented, the relative movement taking place over a pre-determined time period following actuation or on actuation of said movement means, characterized in that the movement means are arranged such that the amount of movement and/or speed of movement of the movement means defines the pre-determined time period of the timing means for which electrical current can flow through the device (4).

42. A device according to claim 41 wherein the device (4) allows substantially simultaneous actuation/deactivation of a plurality of plugs and/or sockets connected to the cable at that time of use.

43. A device according to claim 41 wherein the electrical cable is in the form of an extension cable (2) having a first end (10) with electrical plug means (12) provided thereon or associated therewith, and a second end (14) with one or more electrical sockets (18) provided thereon or associated therewith.

44. A device according to claim 41 wherein the device includes at least first and second parts wherein the movement means allows relative movement of the first and/or second parts, and wherein the movement of the first and/or second parts allows the electrical switch means (64) or the at least first and second electrical connection means (66, 68) to move between the first and second positions.

45. A device according to claim 44 wherein the at least first and second parts at least partially form a housing (30) defining the timing device (4).

46. A device according to claim 44 wherein the at least first and second parts are slidably mounted to allow sliding movement of said parts between said first and second positions.

47. A device according to claim 44 wherein the first part includes or forms a base (32) of the timing device (4) and the second part includes or forms a top (34) of the timing device (4).

48. A device according to claim 47 wherein the user actuates relative movement of the movement means by moving the second top part (34) relative to the first base part (32).

49. A device according to claim 41 wherein the movement means moves automatically from the second position to the first position after a pre-determined time period has elapsed following actuation thereof without further user intervention.

50. A device according to claim 41 wherein means are provided to bias the timing device (4) from the first “in-use” position to the second “out-of-use” position, said biasing means including any, or any combination, of resilient biasing means, in which the uncoiling or flexing of resilient means takes place substantially over said pre-determined time period; pneumatic means in which the passage or movement of air or gas from a first location to a second location takes place over said pre-determined time period; hydraulic means in which the passage of water or fluid from a first location to a second location takes place over said pre-determined period and/or mechanical means.

51. A device according to claim 41 wherein a plurality of predetermined time periods can be set such that the user, third party and/or manufacturer can select which time period they wish to use with the timing device (4).

52. A device according to claim 51 wherein adjustment means are provided to allow user adjustment or selection of the one or more pre-determined time periods.

53. A device according to claim 41 wherein the first and second electrical connection means (66, 68) are associated with the first and second parts respectively, such that the movement of the first and second parts causes the first and second electrical connection means to move between the first and second positions.

54. A device according to claim 41 wherein the device (4) includes indication means to allow a user to determine the status of the timing device.

55. A method of using a timing device (4) in combination with an electrical cable, said device locatable between two ends (10, 14) of the cable and including cable input means and cable output means, said device further including at least first electrical connection means (66) for allowing electrical connection with a first cable part (6) associated with the cable input means in use and at least second electrical connection means (68) for allowing electrical connection with a second cable part (8) associated with the cable output means in use, said method including the step of actuating movement means associated with the device to allow relative movement of the at least first and/or second electrical connection means or an electrical switch means associated with the same between a first position, wherein electrical charge can flow therebetween, and a second position, wherein the flow of electrical charge is prevented, the relative movement taking place over a predetermined time period following actuation or on actuation of said movement means, characterized in that the movement means are arranged such that the amount of movement and/or speed of movement of the movement means defines the pre-determined time period of the timing means for which electrical current can flow through the device (4).
